(19) United States
(12) Patent Application Publication
(10) Pub. No.: US 2006/0274664 A1
(43) Pub. Date: Dec. 7, 2006

(54) Characterization of Voice over Internet Protocol (VoIP) network

(76) Inventor: Harshang Pandya, Singapore (SG)

Correspondence Address: AGILENT TECHNOLOGIES INC., INTELLECTUAL PROPERTY ADMINISTRATION, M/S DU404, P.O. BOX 7599, LOVELAND, CO, 80537-0599, US

(21) Appl. No.: 11/144,501

(22) Filed: Jun. 2, 2005

(51) Int. Cl. H04L 12/26

(52) U.S. Cl. 370/249

(57) ABSTRACT

In one embodiment, a method for characterizing a VoIP network commences with the sending of a plurality of predefined messages from a calling end of the VoIP network. One of the messages is a call initiation message that is sent to a called end of the network. In response to sending the messages, the calling end of the VoIP network receives a plurality of predefined response messages. A plurality of delays are then calculated, with each delay being a function of at least two timing measurements selected from 1) times at which the messages are sent, and 2) times at which the response messages are received. The VoIP network is then characterized by comparing the delays to programmable reference values. Other embodiments are also disclosed.

### BACKGROUND

Voice over Internet Protocol (voice-over-IP or VoIP) is an increasingly popular alternative to public switched telephone networks (PSTN). Just as files may be sent over the Internet or a similar network, a live feed from a microphone and/or camera may be digitized and transmitted over a VoIP network as packetized data. A receiver then reverses the process and hears, or sees, the feed from the sender.

When evaluating a VoIP network, the delay involved in sending packetized data between calling and called ends of the network is a gross indicator of potential problems with the network. However, this single delay may be inadequate to effectively diagnose and alleviate problems with the network.

### SUMMARY OF THE INVENTION

In one embodiment, a method for characterizing a VoIP network commences with the sending of a plurality of predefined messages from a calling end of the VoIP network. One of the messages is a call initiation message that is sent to a called end of the network. In response to sending the messages, the calling end of the VoIP network receives a plurality of predefined response messages. A plurality of delays are then calculated, with each delay being a function of at least two timing measurements selected from 1) times at which the messages are sent, and 2) times at which the response messages are received. The VoIP network is then characterized by comparing the delays to programmable reference values. Other embodiments are also disclosed.

### BRIEF DESCRIPTION OF THE DRAWINGS

Illustrative embodiments of the invention are illustrated in the drawings, in which:

FIG. 1 illustrates an exemplary method for characterizing a VoIP network;

FIG. 2 illustrates a first exemplary block diagram of a VoIP network; and

FIG. 3 illustrates a second exemplary block diagram of a VoIP network.

### DETAILED DESCRIPTION

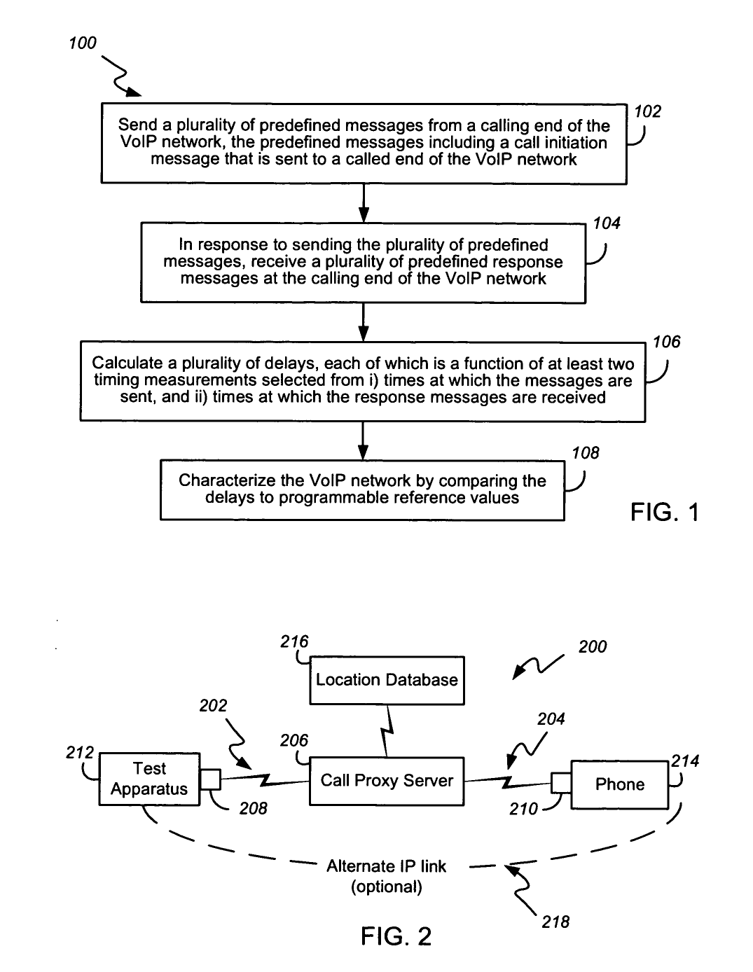

The setup of a VoIP call involves the sending and receiving of a number of predefined messages. In this context, FIG. 1 illustrates an exemplary method 100 for characterizing a Voice over Internet Protocol (VoIP) network. The method 100 commences with the sending 102 of a plurality of predefined messages from a calling end of the VoIP network. One of the messages is a call initiation message that is sent to a called end of the VoIP network. In response to sending the messages, the calling end of the VoIP network receives 104 a plurality of predefined response messages. A plurality of delays are then calculated 106, with each delay being a function of at least two timing measurements selected from 1) times at which the messages are sent, and 2) times at which the response messages are received. The VoIP network is then characterized 108 by comparing the delays to programmable reference values. In one embodiment, the network is characterized by rating the delays, and/or by identifying a part of the network (e.g., a network segment, network element, network server, or protocol stack) that is likely to be affected by each of the delays.

FIG. 2 illustrates an exemplary VoIP network 200 over which the method 100 may be implemented. In general, the network 200 comprises first and second network segments 202, 204 and a call proxy server 206. The first network segment 202 connects a calling end 208 of the VoIP network 200 to the call proxy server 206, and the second network segment 204 connects a called end 210 of the VoIP network 200 to the call proxy server 206. In some cases, the first and second network segments 202, 204 may simply be wire or fiber optic lines. In other cases, the network segments 202, 204 may comprise switches, routers and other forms of communications equipment.

Typically, a VoIP network 200 will be bidirectional. Thus, the labeling of the “calling” and “called” ends 208, 210 of the network 200 are arbitrary and, depending on the end of the network 200 from which a call is initiated, the labels given to the ends of the network 200 can be dynamically reassigned. It is also noted that most VoIP networks comprise a plurality of nodes, each of which can be dynamically reassigned to take the form of a “calling end”, a “called end” or an inactive node.

When implementing the method 100 over the network 200, apparatus 212 for characterizing the network 200 must be connected to at least one end 208 of the network 200 (i.e., the end that is to be the calling end). The same or different apparatus 214 may be connected to the other end 210 of the network 200. In one embodiment, the apparatus 212 for characterizing the network 200 may be a handheld device, such as a handheld network tester. In another embodiment, the apparatus 212 may be a computer, such as a desktop or laptop computer. In yet another embodiment, the apparatus 212 may be a VoIP telephone which has been programmed to store and execute instructions for performing the method 100. In any event, the apparatus 212 for characterizing the network 200 may comprise an interface to connect to the calling end 208 of the VoIP network 200. The apparatus 212 may also comprise computer readable media (e.g., a fixed or removable memory or disk) having stored thereon code that, when executed, performs the method 100.

A first message that may be sent by the apparatus 212 is a ping message. The ping message may be sent to a call proxy server 206 to which the call initiation message has been (or will be) routed. In response to sending the ping message, the apparatus 212 may receive a ping response. A ping delay may then be calculated as a function of the difference between the time the ping message is sent and the time the ping response is received. Given that a ping message requires little overhead for the call proxy server 206 to process, the ping delay may be compared to one or more programmable reference values to characterize the first network segment 202. As will be discussed in greater detail later in this description, the network segment 202 may be characterized by rating the ping delay on a pass/fail or scaled basis. The ping delay (and network segment) may also be rated numerically, textually or graphically.

In response to sending a call initiation message, the apparatus 212 may receive various response messages. For example, the apparatus 212 may receive a server acknowledgement, which is indicative of the call proxy server 206 having received the call initiation message. An invite delay may then be calculated as a function of 1) the difference between the time the ping message is sent and the time the ping response is received, and 2) the difference between the time the call initiation message is sent and the time the server acknowledgement is received. Depending on the protocol used by the VoIP network 200, the invite delay may be compared to one or more programmable reference values to characterize at least part (i.e., part or all) of the call proxy server 206. As will be discussed in greater detail later in this description, the call proxy server 206 may be characterized by rating the invite delay on a pass/fail or scaled basis. The invite delay (and call proxy server 206) may also be rated numerically, textually or graphically.

The apparatus 212 may also receive a number of acknowledgements from the called end 210 of the network 200. For example, a first acknowledgement from the called end 210 may be 1) transmitted to the apparatus 212 via the call proxy server 206, and 2) indicate that the called end 210 has been contacted in response to the apparatus' sending of the call initiation message. A signaling delay may then be calculated as a function of the difference between the time the server acknowledgement is received and the time the first acknowledgement from the called end 210 is received. Depending on the protocol used by the VoIP network 200, the signaling delay may be compared to one or more programmable reference values to characterize at least part (i.e., part or all) of the call proxy server 206 and the second network segment 204. For example, if the VoIP protocol is SIP (Session Initiation Protocol), the invite delay may be used to characterize the SIP protocol stack of the call proxy server 206. As will be discussed in greater detail later in this description, the call proxy server 206 and the second network segment 204 may be characterized by rating the signaling delay on a pass/fail or scaled basis. The signaling delay (and call proxy server 206 and second network segment 204) may also be rated numerically, textually or graphically.

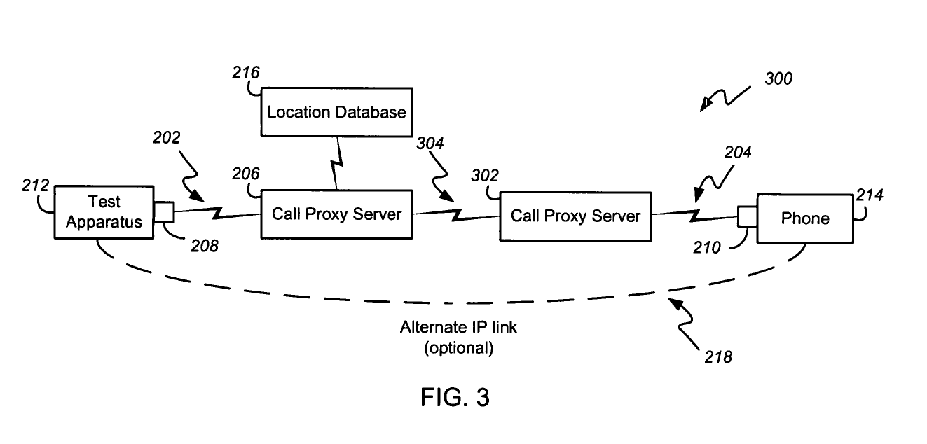

In one embodiment, the signaling delay is also calculated as a function of the delay associated with the second network segment 204. In this manner, the delay associated with the second network segment 204 may be factored out of the signaling delay, and the signaling delay may be compared to one or more programmable reference values to characterize at least part of the call proxy server 206 (e.g., the utilization level of, or load on, the call proxy server 206). The signaling delay may also be used to characterize the call proxy server's access of a location database 216 (e.g., a database accessed by an SIP call proxy server 206 to identify the IP address, phone number or location of a called end 210 of a VoIP network 200). Or, in the alternate network configuration 300 shown in FIG. 3, the signaling delay may be used to characterize all or part of a chain of proxy servers 206, 302 and network segments 304 that are coupled between the first and second network segments 202, 204.

The second network segment 204 may be characterized in various ways. In one embodiment, the called end 210 of the VoIP network 200 may be caused (e.g., by the apparatus 212) to send a ping message to a proxy server 206 from which the called end 210 receives a call based on the call initiation message. Information regarding the second ping message, and a response thereto, may then be caused to be sent to the calling end 208 of the VoIP network 200. This information may then be used to characterize the delay associated with the second network segment 204, similarly to how the first network segment 202 may be characterized.

The apparatus 212 may also receive a second acknowledgement from the called end 210 of the network 200. The second acknowledgement may be similar to the first acknowledgement, but may be transmitted over a link 218 between the called and calling ends 210, 208 that does not include the call proxy server 206. Given the first and second acknowledgements from the called end 210 of the network 200, a signal path delay may be calculated as a function of the difference between the times the first and second acknowledgements are received.

In one embodiment, an aggregate delay of the VoIP network 200 may be calculated from the various message send and receive times, or from the delays calculated therefrom. For example, the aggregate delay may be calculated as an average of the ping delay, the invite delay, the signaling delay and the signal path delay. The aggregate delay may then be compared to one or more of the reference values to characterize the VoIP network 200 as a whole.

Any or all of the delays disclosed herein, as well as others that might be calculated, may be rated on a pass/fail or scaled basis. That is, they may be rated, for example, based on 1) whether they exceed a reference value, 2) their proximity to a reference value, or 3) their relation to a plurality of reference values. The delays may also be rated numerically (e.g., on a scale of 1-5), textually (e.g., poor, average, or excellent) or graphically (e.g., by color coding, or by a “thumbs up” or “thumbs down”)—making them easier for a user to comprehend.

Preferably, the apparatus 212 is provided with a display. In this manner, characterizations of a VoIP network 200 may be displayed on the display. For example, each delay associated with the network 200 may be rated by comparing it to a programmable reference value. The delay ratings may then be displayed along with the parts of the network 200 that are likely to be affected by the delays.

The programmability of the reference values to which delays are compared enables the apparatus 212 to be used in evaluating different VoIP networks. The programmable reference values also enable a user to program reference values corresponding to a desired network Quality of Service (QoS).

The methods 100 and apparatus 212 disclosed herein are useful, in one respect, in that they may be used to identify the likely cause of delay in a VoIP network. Furthermore, they can do so with relatively little overhead. Unlike many prior methods and apparatus that tap into a VoIP network 200 and sample and analyze packets transmitted over the network 200, the methods 100 and apparatus 212 disclosed herein transmit signals over a VoIP network 200 in the usual way. As a result, the methods 100 and apparatus 212 disclosed herein can sometimes result in a more accurate characterization of a VoIP network 200 (and the segments and elements thereof).

Although the methods 100 and apparatus 212 disclosed herein have in some cases been described in the context of a VoIP network 200 implementing the SIP protocol, the methods 100 and apparatus 212 apply to VoIP networks implementing other protocols, such as the ITU/T H.323 protocol.

What is claimed is:

1. A method for characterizing a Voice over Internet Protocol (VoIP) network, comprising:
sending a plurality of predefined messages from a calling end of the VoIP network, the predefined messages including a call initiation message that is sent to a called end of the VoIP network;
in response to sending the plurality of predefined messages, receiving a plurality of predefined response messages at the calling end of the VoIP network;
calculating a plurality of delays, each of which is a function of at least two timing measurements selected from i) times at which the messages are sent, and ii) times at which the response messages are received; and
characterizing the VoIP network by comparing the delays to programmable reference values.

2. The method of claim 1, wherein:
the plurality of predefined messages further comprises a ping message that is sent to a call proxy server to which the call initiation message is routed;
the plurality of predefined response messages comprises a ping response; and
the delays comprise a ping delay that is a function of the difference between the time the ping message is sent and the time the ping response is received.

3. The method of claim 2, wherein characterizing the VoIP network comprises characterizing a first network segment connecting the calling end of the VoIP network to the call proxy server, the first network segment being characterized by comparing the ping delay to one or more of the programmable reference values.

4. The method of claim 2, wherein:
the plurality of predefined response messages comprises a server acknowledgement, which is indicative of the call proxy server having received the call initiation message; and
the delays comprise an invite delay that is a function of i) the difference between the time the ping message is sent and the time the ping response is received, and ii) the difference between the time the call initiation message is sent and the time the server acknowledgement is received.

5. The method of claim 4, wherein characterizing the VoIP network comprises characterizing at least part of the call proxy server, the at least part of the call proxy server being characterized by comparing the invite delay to one or more of the programmable reference values.

6. The method of claim 4, wherein:
the plurality of predefined response messages comprises a first acknowledgement from the called end, the first acknowledgement i) being transmitted through the call proxy server, and ii) indicating that the called end has been contacted in response to the call initiation message; and
the delays comprise a signaling delay that is a function of the difference between the time the server acknowledgement is received and the time the first acknowledgement from the called end is received.

7. The method of claim 6, wherein the signaling delay is also a function of a delay associated with a second network segment connecting the called end of the VoIP network to a proxy server from which the called end receives the call.

8. The method of claim 7, wherein characterizing the VoIP network comprises characterizing access of a location database server, the access of the location database server being characterized by comparing the signaling delay to one or more of the programmable reference values.

9. The method of claim 7, wherein characterizing the VoIP network comprises characterizing part or all of a chain of proxy servers and network segments coupled between the first and second network segments, the chain of proxy servers being characterized by comparing the signaling delay to one or more of the programmable reference values.

10. The method of claim 7, further comprising:
causing the called end of the VoIP network to send a second ping message, the second ping message being sent to a proxy server from which the called end receives a call based on the call initiation message;
causing information regarding the second ping message, and a response thereto, to be sent to the calling end of the VoIP network; and
using the information to characterize the delay associated with the second network segment.

11. The method of claim 10, wherein characterizing the VoIP network comprises characterizing the second network segment, the second network segment being characterized by comparing the delay associated with the second network segment to one or more of the programmable reference values.

12. The method of claim 6, wherein:
the plurality of predefined response messages comprises a second acknowledgement from the called end, the second acknowledgement i) being transmitted over a link between the called and calling ends that does not include the call proxy server, and ii) indicating that the called end has been contacted in response to the call initiation message; and
the delays comprise a signal path delay that is a function of the difference between the times the first and second acknowledgements are received.

13. The method of claim 8, wherein the delays comprise an aggregate delay of the VoIP network.

14. The method of claim 1, wherein characterizing the VoIP network comprises rating at least some of the delays in response to the comparisons of the delays to the programmable reference values.

15. The method of claim 14, wherein at least some of the delays are rated numerically.

16. The method of claim 14, wherein at least some of the delays are rated textually.

17. The method of claim 14, wherein at least some of the delays are rated graphically.

18. The method of claim 14, wherein at least some of the delays are rated on a pass/fail basis.

19. The method of claim 14, wherein characterizing the VoIP network comprises identifying a part of the network that is likely to be affected by each of the delays.

20. The method of claim 6, wherein characterizing the VoIP network comprises rating each delay in response to the comparisons of the delays to the programmable reference values.

21. Apparatus for characterizing a Voice over Internet Protocol (IP) network, comprising:
an interface to connect to a calling end of the VoIP network; and
computer readable media having stored thereon code to:
send a plurality of predefined messages through the interface, the predefined messages including a call initiation message that is sent to a called end of the VoIP network;
in response to sending the plurality of predefined messages, receive a plurality of predefined response messages through the interface;
calculate a plurality of delays, each of which is a function of at least two timing measurements selected from i) times at which the messages are sent, and ii) times at which the response messages are received; and
characterize the VoIP network by comparing the delays to programmable reference values.

22. The apparatus of claim 21, further comprising a display to display the characterizations of the VoIP network.

23. The apparatus of claim 22, further comprising code to rate each delay in response to the comparisons of the delays to the programmable reference values; wherein the ratings are displayed on the display.

24. The apparatus of claim 23, further comprising code to identify a part of the network that is likely to be affected by each of the delays; wherein the parts of the network are displayed on the display along with a corresponding delay rating.

25. The apparatus of claim 23, wherein the apparatus is a handheld device.

26. The apparatus of claim 23, wherein the apparatus is a VoIP telephone.
